(19) United States
(12) Patent Application Publication
(10) Pub. No.: US 2014/0001188 A1
(43) Pub. Date: Jan. 2, 2014

(54) TRANSPORT CONTAINERS FOR PRESERVING MATERIAL AT A DESIRED TEMPERATURE

(71) Applicants: Moon Nahm, Mountain Brook, AL (US); William Benjamin, JR., Birmingham, AL (US)

(72) Inventors: Moon Nahm, Mountain Brook, AL (US); William Benjamin, JR., Birmingham, AL (US)

(21) Appl. No.: 14/005,349

(22) PCT Filed: Mar. 21, 2012
(86) PCT No.: PCT/US12/29892

§ 371 Date: Sep. 16, 2013

Related U.S. Application Data
(60) Provisional application No. 61/454,762, filed on Mar. 21, 2011.

(51) Int. Cl. A61J 1/16; F28D 20/00

(52) U.S. Cl. CPC A61J 1/16; F28D 20/0056
USPC 220/592.01; 126/400

(57) ABSTRACT

In one embodiment, a transport container includes a body that contains temperature preserving material having a melting point of higher than that of water and a compartment adapted to receive a sample of material that is to be maintained at an elevated temperature.

### CROSS-REFERENCE TO RELATED APPLICATION

This application claims priority to copending U.S. provisional application entitled, “Designing and Producing a Device for Preserving Temperature at 37 Degree C.,” having Ser. No. 61/454,762, filed Mar. 21, 2011, which is entirely incorporated herein by reference.

### BACKGROUND

In certain situations, it is desirable to maintain a material at a particular temperature. One example of this is biological material, such as blood. Cryoglobulin is a common and simple clinical immunology laboratory test that requires the samples to be transported to the laboratory without cooling at 37° C. To achieve this, samples are typically hand delivered to the laboratory in an insulated container containing warm water. Investigation of the arrival temperatures of such samples, however, has revealed that over 75% of samples arrive at or below 36° C. In addition to situations in which the sample arrives at too low of a temperature, it is difficult to regulate the exact temperature of warm water, which occasionally results in the use of water that is too hot, in which case the sample can be damaged.

From the above discussion, it can be appreciated that it would be desirable to have an apparatus that can be used to maintain a material at a desired temperature for an extended period of time.

### BRIEF DESCRIPTION OF THE DRAWINGS

The present disclosure may be better understood with reference to the following figures. Matching reference numerals designate corresponding parts throughout the figures, which are not necessarily drawn to scale.

FIG. 1 is an exploded perspective view of an embodiment of a transport container for maintaining material at a desired temperature.

FIG. 2 is a cross-sectional side view of a body of the transport container of FIG. 1.

FIG. 3 is an exploded perspective view of the transport container of FIG. 1 with sample vials provided within compartments of the container.

FIG. 4 is a perspective view of the transport container of FIG. 1 with a lid of the container shown attached to the body of the container.

FIG. 5 is a perspective view illustrating the transport container of FIG. 1 placed within a pneumatic delivery container.

FIG. 6 is a graph that plots temperature versus time for various temperature preserving materials.

FIG. 7 is a graph that plots temperature versus time for experiments with a prototype transport container.

FIG. 8 is a side view of alternative apparatus that can be used to maintain material at a desired temperature.

### DETAILED DESCRIPTION

As described above, it would be desirable to have an apparatus that can be used to maintain a material at a desired temperature for an extended period of time. Disclosed herein are transport containers that can be used to maintain a desired temperature, such as an elevated temperature. In some embodiments, the containers contain a temperature preserving material and one or more compartments that are adapted to receive a sample of material. In some embodiments, the temperature preserving material is a wax material that has a melting point that is within a few degrees higher than a temperature at which the sample is to be maintained. In some embodiments, the compartments comprise elongated tubes that are adapted to receive sample vials.

In the following disclosure, various specific embodiments are described. It is to be understood that those embodiments are example implementations of the disclosed inventions and that alternative embodiments are possible. All such embodiments are intended to fall within the scope of this disclosure.

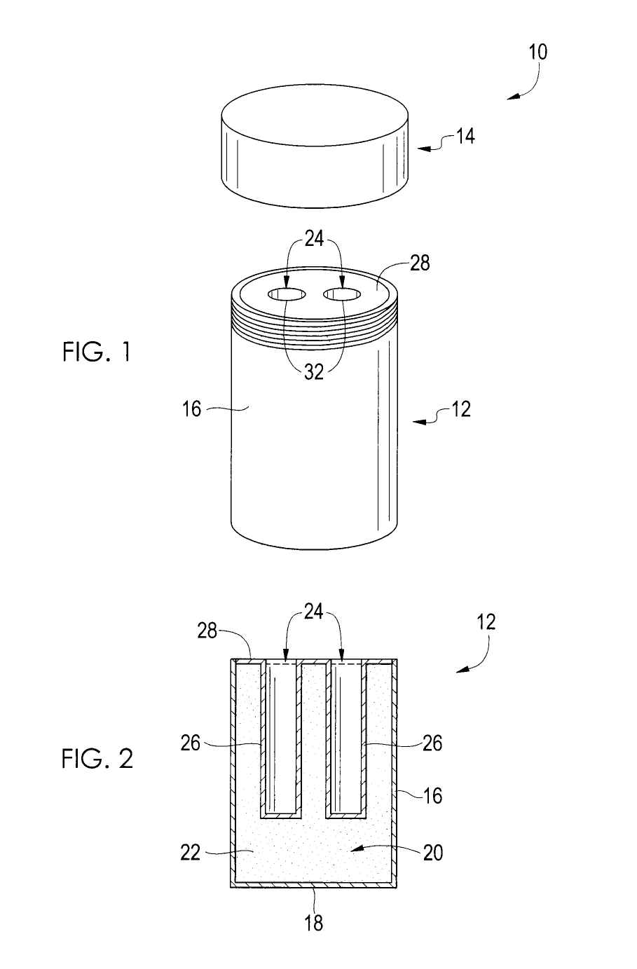

FIGS. 1 and 2 illustrate an example transport container 10 that overcomes problems associated with current material transport. As is shown in the figure, the container 10 generally comprises a body 12 and a lid 14. The body 12 is rigid, generally cylindrical and includes a continuous wall 16 that extends up from a base 18. By way of example, the body 12 can be approximately 19 to 20 centimeters (cm) tall and have a diameter of approximately 8 to 10 cm. Although a cylindrical body is shown in the figures and has been described, it is noted that other shapes and configurations are possible. For example, the body 12 could instead be box shaped, in which case it would include multiple walls.

The wall 16 and the base 18 of the body 12 together define an interior space 20 of the body. The interior space 20 contains a temperature preserving material 22 that, as is described below, can be used to maintain a sample material at a desired temperature. The temperature preserving material 22 has a specific heat and a melting point higher than that of water. In some embodiments, the temperature preserving material comprises a wax material having a melting point of approximately 5.5° C. to 75° C. In other embodiments, the wax material has a melting point slightly higher than normal human body temperature, i.e., approximately 37° C. to 45° C. Example wax materials include N-docosane, N-eicosane, and mixtures thereof. N-docosane and N-eicosane have melting points of approximately 42-45° C. and 36-38° C., respectively, with a high heat of fusion required for the phase transition. When mixed together in an approximately 50/50 ratio, the mixture can have a specific heat that is approximately 200 kilojoules per kilogram (kJ/kg) to 246kJ/kg and a melting point of approximately 38° C., which is desirable for maintaining a sample material, such as blood, at a temperature of approximately 37° C. In some embodiments, the container 10 can hold approximately 300 to 400 grams of the temperature preserving material 22.

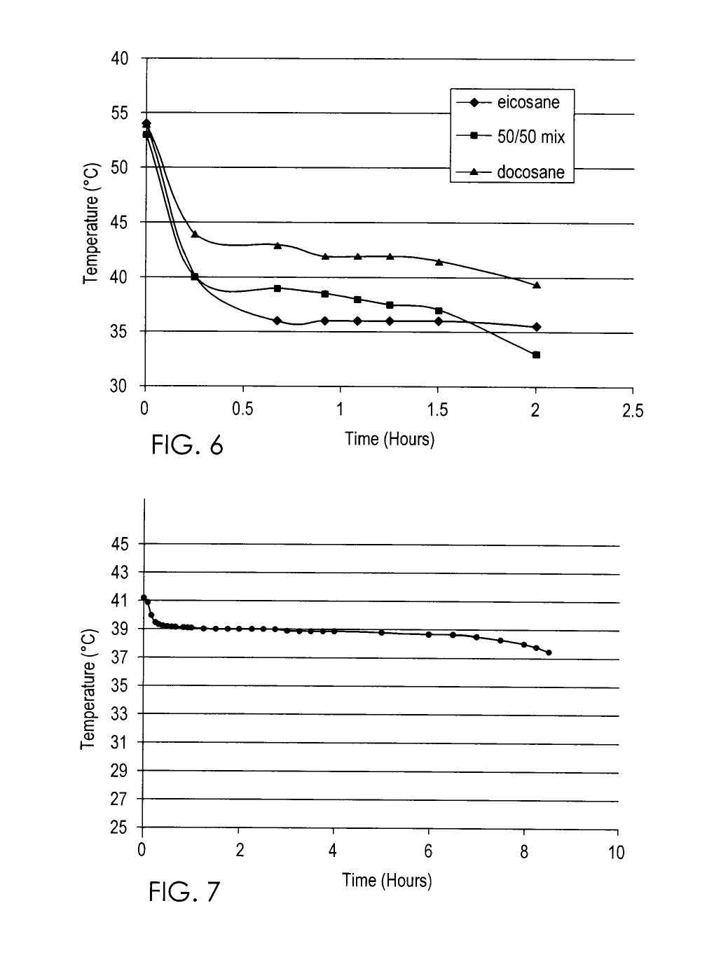

FIG. 6 is a graph that plots temperature versus time for N-docosane, N-eicosane, and a 50/50 mixture of N-docosane and N-eicosane that were obtained using a prototype transport container of the type described above.

In other embodiments, the temperature preserving material comprises another material having a melting point just greater than the temperature at which the sample material is desired to be maintained. For example, the temperature preserving material alternatively could can be one or more salts, such as sodium sulfate.

In some embodiments, the temperature preserving material can include a heat conducting material such as a metal (e.g., aluminum, copper) to assist the temperature preserving material in absorbing and transmitting heat.

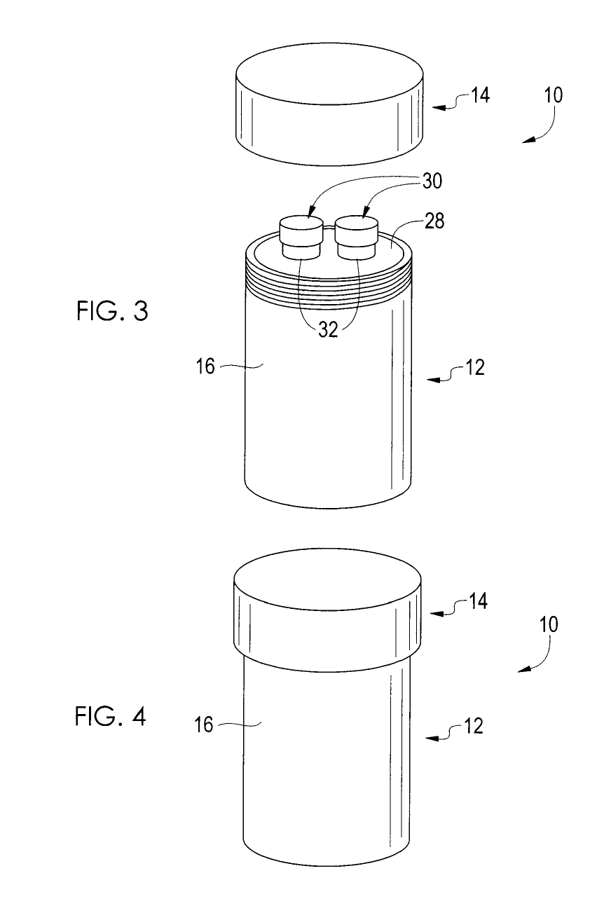

With further reference to FIGS. 1 and 2, the body 12 forms multiple compartments 24 that are adapted to receive and secure samples. In some embodiments, the compartments 24 are formed by cylindrical tubes 26 that are integrated with a cap 28 that extends across the top of the body 12. Such compartments 24 are suited to receive sample vials, such as vacutainer tubes that can be used to hold blood. FIG. 3 shows two sample vials 30 that have been placed in the compartments 24 through openings 32 in the cap 28.

The components of the body 12 can be made of various materials. In some embodiments, the body 12 is made of a clear or opaque rigid polymeric material. In cases in which the body 12 is clear, the state of the temperature preserving material 22 will be visually apparent. For example, when the temperature preserving material 22 is wax, the liquid wax can be clear while the solidified (frozen) wax can be opaque. In other embodiments, the body 12 can be made of glass or a metal material.

Once one or more samples have been placed within the body 12, the lid 14 can be secured to the body. In some embodiments, the top of the body 12 is threaded to engage similar threads of the lid 14 (not shown). In such a case, the lid 14 can be securely screwed onto the body 12. In other embodiments, the lid 14 can secure to the body 12 with a snap fit or other attachment scheme. Regardless, the lid 14 attaches to the body 12 in a manner in which there is sufficient space for the tops of the sample vials 30. FIG. 4 shows the lid 14 in place on the body 12.

The transport container can be used to maintain the temperature of a sample material for several hours so that the material will arrive at its destination at the desired temperature. In an example method, the transport container is heated in an incubator or other heating apparatus to a temperature that is within a few degrees higher than the melting temperature of its temperature preserving material. Where the sample material is blood, that melting temperature can be approximately 39° C. and the container can be heated to approximately 40° C. to 42° C. Once all of the temperature preserving material has melted, the container can be removed from the incubator and one or more sample vials can be placed within the one or more compartments of the body, and the lid can be secured to the body. Within minutes, the temperature preserving material will cool and begin to solidify (freeze). As the temperature preserving material solidifies it releases heat within a narrow temperature range for many hours. This is due to the high heat capacity of the temperature preserving material, which is many times greater than that of water. FIG. 7 illustrates how long the desired temperature can be maintained. Specifically, FIG. 7 plots the temperature of a 50/50 mixture of N-docosane and N-eicosane contained within in a prototype transport carrier. As can be appreciated from the figure, the tested temperature preserving material maintained a temperature of approximately 39° C. for approximately 6 hours.

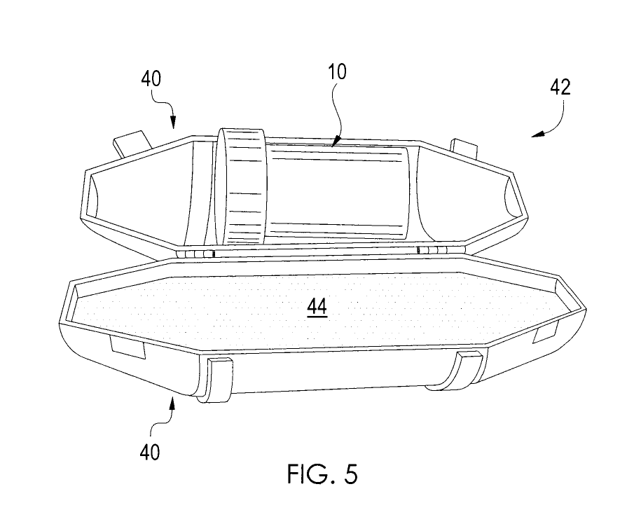

The transport container can be transported in various ways, including by hand carrying. In some embodiments, however, the transport container 10 is sized and configured to fit within a pneumatic delivery container so that the transport container can be delivered using a conventional pneumatic delivery system, as one may find in a hospital. FIG. 5 shows an example of this. In that figure, the transport container 10 is shown placed in one of two halves 40 of a pneumatic delivery container 42, such as a Swisslog pneumatic delivery container. Padding 44 is provided in the other half 40 of the pneumatic delivery container 42 to secure the transport container 10 and avoid damage to that container or the samples it contains.

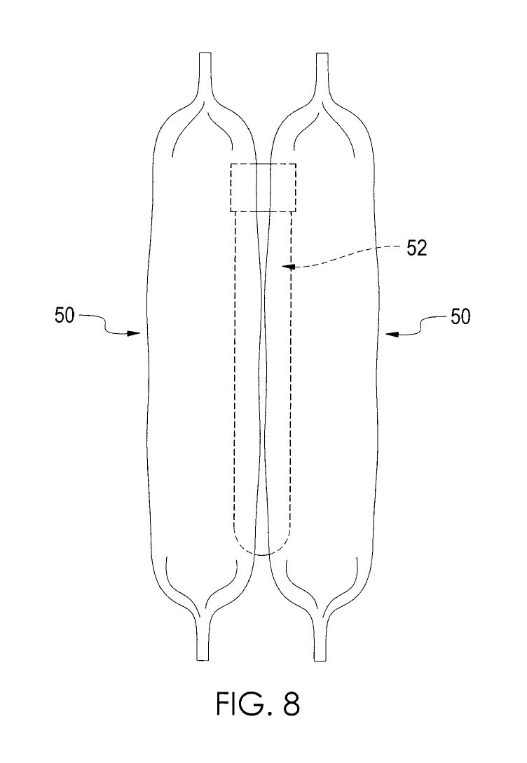

Although a transport container having a particular configuration has been described above, it is noted that the nature of the container is not as important as the utilization of a suitable temperature preserving material. Accordingly, in other embodiments, the temperature preserving material can be provided in bags or pouches that can be used as temperature preserving elements that wrap around a sample, such as a sample vial. FIG. 8 illustrates an example of this. Instead of a rigid container, one or more flexible bags 50 that contain temperature preserving material are provided that can surround a sample vial 52 prior to freezing of the material, and the bags/vial can then be placed in another container, such as a conventional insulated container or pneumatic delivery container, for transport. In some embodiments, the bags 50 are made of a polymeric material that is flexible and/or elastic enough to prevent rupture when the temperature preserving material solidifies. In other embodiments, the temperature preserving material contains an additive, such as kaolin, that makes the temperature preserving material softer in its solidified state.

1. A transport container comprising:
a body that contains temperature preserving material having a melting point of higher than normal human body temperature and a compartment adapted to receive a sample of material that is to be maintained at an elevated temperature.

2. The container of claim 1, wherein the body is made of a clear material so that the temperature preserving material can be seen from outside of the container.

3. The container of claim 1, wherein the body is cylindrical.

4. The container of claim 1, wherein the temperature preserving material is a wax material.

5. The container of claim 4, wherein the wax material includes N-docosane, N-eicosane, or both.

6. The container of claim 4, wherein the wax material includes an approximately 50/50 mixture of N-docosane and N-eicosane.

7. The container of claim 1, wherein the temperature preserving material has a melting point of approximately 37° C. to 45° C.

8. The container of claim 1, wherein the temperature preserving material has a melting point of approximately 38° C.

9. The container of claim 1, wherein the temperature preserving material includes a heat conducting material.

10. The container of claim 9, wherein the heat conducting material comprises a metal.

11. The container of claim 1, wherein the compartment is a tube adapted to receive a sample vial.

12. The container of claim 1, wherein the body comprises multiple compartments each adapted to receive a sample of material that is to be maintained at an elevated temperature.

13. The container of claim 1, further comprising a lid adapted to attach to the body.

14. A temperature preserving element comprising:
a flexible polymeric bag that is filled with a temperature preserving material having a melting point higher than normal human body temperature.

15. The element of claim 14, wherein the temperature preserving material is a wax material.

16. The element of claim 15, wherein the wax material includes N-docosane, N-eicosane, or both.

17. The element of claim 15, wherein the wax material includes an approximately 50/50 mixture of N-docosane and N-eicosane.

18. The element of claim 14, wherein the temperature preserving material has a melting point of approximately 37° C. to 45° C.

19. The element of claim 14, wherein the temperature preserving material has a melting point of approximately 38° C.

20. The element of claim 14, wherein the temperature preserving material includes a heat conducting material.

21. The element of claim 20, wherein the heat conducting material is a metal.

22. The element of claim 14, wherein the temperature preserving material includes an additive that makes the temperature preserving material softer in its solidified state.

23. The element of claim 22, wherein the additive is kaolin.
